(19) United States
(12) Patent Application Publication
(10) Pub. No.: US 2026/0233544 A1
(43) Pub. Date: Aug. 13, 2026

(54) PROTECTIVE PATCH RIBBON FOR THERMAL TRANSFER PRINTERS AND METHOD FOR MANUFACTURING THE SAME

(71) Applicant: RTAI INC CO.,LTD, Hwaseong-si (KR)

(72) Inventors: Yong-Jin JANG, Anseong-si (KR); Cheol-Hyeon LIM, Pyeongtaek-si (KR); Hong-Joo JEON, Gwangju (KR); Hyeon-Min KANG, Gunsan-si (KR)

(21) Appl. No.: 18/878,436

(22) PCT Filed: Sep. 21, 2023
(86) PCT No.: PCT/KR2023/014396

§ 371 Date: Dec. 23, 2024

(30) Foreign Application Priority Data
Sep. 26, 2022 (KR) 10-2022-0121322

(51) Int. Cl. B41M 5/382; B41M 5/385; B41M 5/44

(52) U.S. Cl. CPC B41M 5/38214; B41M 5/385; B41M 5/443; B41M 2205/30; B41M 2205/38

(57) ABSTRACT

Provided is a protective patch ribbon for thermal transfer printers that allows images or intended information to be directly to be recorded onto the patch shape-imparting body using existing retransfer printers without requiring a separate laminator, as well as effectively preventing physical damage to the records transferred onto the recording medium and preventing forgery or tampering of the transferred records. The protective patch ribbon includes: a peeling body comprising a transport film that undergoes repeated unrolling and winding, and a cohesion layer located on at least one side of the transport film; a patch shape-imparting body comprising a structure in which a patch film base material and a primer layer are sequentially stacked on the cohesion layer, wherein the structure includes a cut-out area; and an image receiving layer located on the patch shape-imparting body, wherein the patch shape transferred to the recording medium is defined by the cut-out area.

### TECHNICAL FIELD

The present invention relates to a protective patch ribbon for thermal transfer printers and a method for manufacturing the same, and more specifically, it pertains to a protective patch ribbon for thermal transfer printers that, in addition to providing protection for the records transferred to a recording medium and preventing alterations of the transferred material, enables high-quality image printing even on the edge regions of the recording medium using conventional retransfer printers.

### BACKGROUND ART

Information is printed on plastic cards such as credit cards, and transportation cards, and identity cards such as resident registration cards, and driver's licenses, which serve as recording media.

Among various printing methods, the direct thermal transfer method, which prints images directly onto the recording medium, has the limitation that print quality deteriorates in the edge regions of the recording medium.

To overcome this limitation, a retransfer method is widely used, in which the desired image is first printed onto an intermediate transfer medium and then transferred onto the recording medium through thermal lamination, transferring the coating layer of the intermediate transfer medium onto the recording medium.

However, to prevent physical damage to the records retransferred onto the recording medium, an additional process of attaching a protective patch onto the transferred material on the recording medium is essential. Typically, the protective patch is provided as a protective patch ribbon in which a film with a heat cohesion layer coated on a transport film is laminated. This ribbon is laminated in a single direction to coat the retransferred, records on the recording medium. However, attaching the protective patch to the records requires a separate printer or laminator, which leads to a reduction in process efficiency.

Accordingly, there is a need for a new protective patch ribbon that can provide both image printing and physical protection for the printed image using existing retransfer printers without requiring a separate laminator. This ribbon should replace both conventional protective patches and retransfer intermediate transfer media while enabling high-quality image printing with existing retransfer printers.

[Prior Art Document] Korean Patent Publication No. 10-2017-0100364

### DETAILED DESCRIPTION OF THE INVENTION

### Technical Problem

The objective of the present invention is to provide a protective patch ribbon for thermal transfer printers that effectively prevents physical damage to records transferred to the recording medium, eliminating the need for a separate laminator.

Another objective of the present invention is to provide a protective patch ribbon for thermal transfer printers that prevents alterations to the records transferred to the recording medium.

Another objective of the present invention is to provide a protective patch ribbon for thermal transfer printers that enables high-quality image printing, even on the edge regions of the recording medium.

Another objective of the present invention is to provide a method for manufacturing the aforementioned protective patch ribbon for thermal transfer printers.

### Technical Solution

The protective patch ribbon for thermal transfer printers provided according to the present invention comprises: a peeling body including a transport film that undergoes repeated unrolling and winding, and a cohesion layer located on at least one side of the transport film; a patch shape-imparting body including a structure in which a patch film base material and a primer layer are sequentially stacked on the cohesion layer, wherein the structure includes a cut-out area; and an image receiving layer located on the patch shape-imparting body, wherein the patch shape transferred to the recording medium is defined by the cut-out area.

In one embodiment of the protective patch ribbon for thermal transfer printers according to the present invention, the transport film and the patch film base material may be laminated by the cohesion layer.

In another embodiment of the protective patch ribbon for thermal transfer printers according to the present invention, it may further include a release layer positioned between the image receiving layer and the primer layer.

In one embodiment of the protective patch ribbon for thermal transfer printers according to the present invention, it may further include a first buffer portion that extends integrally from the release layer and fills the cut-out area.

In another embodiment of the protective patch ribbon for thermal transfer printers according to the present invention, the structure may include the release layer, and the peeling body-side end of the cut-out area may be recessed into the interior of the transport film.

In one embodiment of the protective patch ribbon for thermal transfer printers according to the present invention, the cut-out area may be tapered in the thickness direction of the protective patch ribbon.

In one embodiment of the protective patch ribbon for thermal transfer printers according to the present invention, the protective patch ribbon may further include a second buffer portion that extends integrally from the image receiving layer and fills the cut-out area.

In one embodiment of the protective patch ribbon for thermal transfer printers according to the present invention, the peeling strength between the release layer and the layers in contact with the release layer, as well as the peeling strength between the primer layer and the patch film base material, may be greater than the peeling strength between the transport film and the patch film base material.

In one embodiment of the protective patch ribbon for thermal transfer printers according to the present invention, the peeling strength between the transport film and the patch film base material may be range from 4 to 8 gf/25 mm based on a 90-degree peeling test.

In one embodiment of the protective patch ribbon for thermal transfer printers according to the present invention, the cohesion layer may include one or more selected from the group consisting of polyester, polyacrylate, polyurethane, polyimide, polybutyral, polyacetal, and silicone resins.

In one embodiment of the protective patch ribbon for thermal transfer printers according to the present invention, the release layer may include one or more selected from the group consisting of polyester, polyacrylate, polyamide, cellulose ester, polyurethane, polyvinyl acetate copolymer, polybutyral, polyacetal, and silicone resins.

In one embodiment of the protective patch ribbon for thermal transfer printers according to the present invention, the thickness of the cohesion layer and the release layer may each independently be range from 0.5 to 5 μm.

In one embodiment of the protective patch ribbon for thermal transfer printers according to the present invention, the patch film base material may be one or more selected from the group consisting of oriented polypropylene (OPP), polyethylene terephthalate (PET), polyethylene naphthalate (PEN), and polycarbonate (PC).

In one embodiment of the protective patch ribbon for thermal transfer printers according to the present invention, the patch film base material may include an embossed hologram.

In another aspect, the present invention provides a method for manufacturing the protective patch ribbon for thermal transfer printers.

A method for manufacturing the protective patch ribbon for thermal transfer printers according to the present invention comprises the following steps: a) Preparing a peeling body by applying a cohesion layer coating solution to at least one surface of a transport film, which undergoes repeated unrolling and winding to form the cohesion layer; b) Forming a structure, positioned on the peeling body, by stacking a patch film base material onto the cohesion layer, laminating the patch film base material thereto using a thermal laminator, and then forming a primer layer on the opposite side of the laminated surface of the patch film base material; c) Forming a patch shape-imparting body by creating a cut-out area on the structure through a die-cutting process such that the patch shape to be transferred to the recording medium is defined; and d) Forming an image receiving layer on the patch shape-imparting body.

In one embodiment of the method for manufacturing the protective patch ribbon for thermal transfer printers according to the present invention, after step c), it may further include applying a release layer coating solution on the patch shape-imparting body to form a release layer.

In one embodiment of the method for manufacturing the protective patch ribbon for thermal transfer printers according to the present invention, in step b), a release layer coating solution may be applied on the primer layer to form a structure that includes a release layer on the primer layer.

In one embodiment of the method for manufacturing the protective patch ribbon for thermal transfer printers according to the present invention, in step c), the peeling body-side end of the cut-out area may be recessed into the interior of the transport film.

### Effects of the Invention

The protective patch ribbon for thermal transfer printers provided according to the present invention includes: a peeling body including a transport film that undergoes repeated unrolling and winding, and a cohesion layer located on at least one side of the transport film; a patch shape-imparting body including a structure in which a patch film base material and a primer layer are sequentially stacked on the cohesion layer, wherein the structure includes a cut-out area; and an image receiving layer located on the patch shape-imparting body, wherein the patch shape transferred to the recording medium is defined by the cut-out area, allowing images or intended information to be directly to be recorded onto the patch shape-imparting body using existing retransfer printers without requiring a separate laminator. This offers advantages such as effectively preventing physical damage to the records transferred onto the recording medium and preventing forgery or tampering of the transferred records.

### BRIEF DESCRIPTION OF THE DRAWINGS

FIG. 1 is a conceptual diagram illustrating the protective patch ribbon in accordance with one embodiment of the present invention.

FIG. 2 is a conceptual diagram illustrating the protective patch ribbon in accordance with another embodiment of the present invention.

FIG. 3 is a conceptual diagram illustrating the protective patch ribbon in accordance with yet another embodiment of the present invention

### DESCRIPTION OF THE EMBODIMENTS OF THE INVENTION

The protective patch ribbon for thermal transfer printers and its manufacturing method according to an embodiment of the present invention will be described in detail with reference to the attached drawings below.

The drawings introduced below are provided as examples to ensure that the concepts of the present invention are sufficiently conveyed to those skilled in the art. Therefore, the present invention is not limited to the drawings presented here, and may be embodied in other forms. Additionally, the drawings may be exaggerated for the purpose of clarifying the concepts of the present invention.

In the case of technical and scientific terms used herein, unless otherwise defined, they have the meanings commonly understood by those skilled in the relevant technical field. Descriptions of known functions and configurations that could unnecessarily obscure the essence of the present invention in the following explanation and attached drawings are omitted.

Furthermore, the singular form of terms used in this specification and the attached claims is intended to include the plural form unless context specifically indicates otherwise.

In this specification and the attached claims, terms such as “comprise” or “include” refer to the presence of the features or components described, and unless specifically limited, do not preclude the possibility of additional features or components being included.

The protective patch ribbon for thermal transfer printers provided according to the present invention comprises a peeling body including a transport film that undergoes repeated unrolling and winding, and a cohesion layer positioned on at least one surface of the transport film; a patch shape-imparting body which includes a structure in which a patch film base material and a primer layer are sequentially laminated on the cohesion layer, wherein the structure includes a cut-out area; and an image receiving layer positioned on the patch shape-imparting body, wherein the patch shape transferred to the recording medium is defined by the cut-out area.

In a conventional retransfer printing method, the printing of desired information or images (hereinafter referred to as “records”) onto a recording medium using is performed by first printing the records onto an intermediate transfer medium, and then retransferring the records from a coating layer of the intermediate transfer medium onto the recording medium. However, this method results in reduced physical durability of the records, requiring an additional step where a protective patch is applied to the records transferred onto the recording medium using a laminator, in order to prevent physical damage to the records.

Here, the protective patch is generally referred to as a clear patch, clear patch ribbon, clear patch laminate, clear laminate patch or ribbon, or overlaminate clear.

These protective patches are provided in the form of a protective patch ribbon, which is a roll form where a clear patch and a transport film are bonded, and where the records are transferred from the transport film to the recording medium by heat. The thickness of the protective patch is approximately 2 to 3 times thicker than that of the intermediate transfer medium.

Due to the difference in thickness between the protective patch and the intermediate transfer medium, when a relatively thick protective patch is laminated in a retransfer printer that supplies less heat than the laminator used to apply the protective patch, the transfer to the recording medium and adhesive strength may be reduced. As a result, there is a problem of reduced process efficiency because an additional printer or laminator is required to apply the protective patch.

Meanwhile, the protective patch ribbon for thermal transfer printers according to one embodiment of the present invention comprises a peeling body including a transport film that undergoes repeated unrolling and winding, and a cohesion layer positioned on at least one surface of the transport film; a patch shape-imparting body which includes a structure in which a patch film base material and a primer layer are sequentially laminated on the cohesion layer, wherein the structure includes a cut-out area; and an image receiving layer positioned on the patch shape-imparting body, wherein the shape of the patch transferred to the recording medium is defined by the cut-out area. Accordingly, although a conventional retransfer printer, which supplies less heat than the laminator used to apply the protective patch, is employed, the patch shape-imparting body is peeled from the peeling body and thermally bonded to the recording medium. This enables high-quality printing of the records onto the recording medium and effectively prevents physical damage to the transferred, records.

Here, the records can be transferred to any recording medium known in the art, without limitation. For example, the recording medium may include polyvinyl chloride, polyester, polycarbonate, or ABS (Acrylonitrile Butadiene Styrene) resin, but is not limited to these materials.

A more detailed description will follow with reference to the attached drawings.

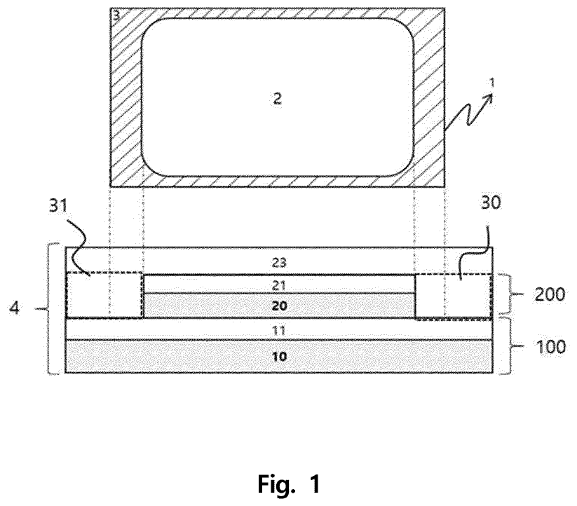

FIG. 1 is a conceptual diagram of a protective patch ribbon (4) according to one embodiment of the present invention.

As shown in FIG. 1, the protective patch ribbon (4) according to one embodiment of the present invention comprises a peeling body (100) including a transport film that undergoes repeated unrolling and winding, and a cohesion layer (11) positioned on at least one surface of the transport film (10); a patch shape-imparting body (200) which includes a structure in which a patch film base material (20) and a primer layer (21) are sequentially laminated on the cohesion layer (11), wherein the structure includes cut-out areas (30, 31); and an image receiving layer (23) positioned on the patch shape-imparting body (200).

The protective patch ribbon (4) may include a plurality of units, arranged continuously in tape form, each unit comprising the peeling body (100), the patch shape-imparting body (200), and the image receiving layer (23).

In this configuration, the shape (2) of the patch transferred to the recording medium (1) is defined by the cut-out areas (30, 31).

Specifically, the peeling body (100) is peeled off, and the image receiving layer (23) on which records is printed, and the patch shape-imparting body (200), are sequentially thermally bonded to the surface of the recording medium (1), thereby transferring the records to the recording medium (1).

As one specific example, the transport film (10) included in the peeling body (100) may undergo repeated unrolling and winding.

Unlike conventional methods, where lamination is performed in a single direction to attach the protective patch, a protective patch ribbon (4) according to one embodiment of the present invention is provided with an image-receiving layer (23) that allows for image transfer. In this method, the image is completed by returning to the starting point after printing each color, such as cyan (Cyan), magenta (Magenta), yellow (Yellow), black (Key), and silver. That is, to enable the image to be received on the image-receiving layer (23), as described later, the transport film (10) can be repeatedly unwound and rewound by a drive roll.

In one embodiment, the transport film (10) may include sensing marks (not shown) on at least one surface to confirm the printing position. These marks may comprise two marks spaced at a certain interval on at least one surface of a single unit, thereby specifying the range of the printing area. The sensing marks can be implemented using black ink, which is commonly used in the industry.

However, if the sensing mark included in the transport film (10), which undergoes repeated unrolling and winding, comes into contact with the image receiving layer (23) during the winding, the properties of the black ink may be selected based on the properties of the image receiving layer (23).

For example, when the transport film (10) is wound for printing, if the surface of the image receiving layer (23) that comes into contact with the sensing mark is oil-based, the sensing mark may contain water-based black ink. Conversely, if the surface of the image receiving layer (23) is water-based, the sensing mark may contain oil-based black ink.

For example, the transport film (10) can be any material known in the industry, without limitation. Non-limiting examples of the material include polyethylene terephthalate (PET), polyethylene naphthalate (PEN), but are not limited to these.

Specifically, the thickness of the transport film (10) may range from 1 to 50 μm, and more specifically, 10 to 30 μm, but the invention is not limited by the thickness of the transport film (10).

As an example, the cohesion layer (11) included in the peeling body (100) and located on one surface of the transport film (10) adheres the patch film substrate (20) included in the patch shape-imparting body (200) to the transport film (10). The cohesion layer (11) plays a role in adjusting the peeling strength between the patch film substrate (20) and the transport film (10) such that the patch shape-imparting body (200) can be peeled from the peeling body (100) during the thermal transfer process.

As an example, the cohesion layer (11) may include thermosetting resins, thermoplastic resins, or photocurable resins. It is preferable that the aforementioned resin, once cured, exhibits little or no stickiness.

As mentioned earlier, the transport film (10) with the cohesion layer (11) may undergo repeated unrolling and winding by a driving roll to allow the image receiving layer (23) to receive images. At this time, if any stickiness caused by the cohesion layer (11) remains on one side of the transport film (10) after the image receiving layer (23) and the patch shape-imparting body (200) are heat-bonded and the printed material is transferred to the recording medium (1), excessive load may be applied to the drive roll responsible for unrolling and winding the transport film (10). This can result in the failure to accurately reach the printing start point for each color, leading to blurry images with misaligned colors. In cases of severe stickiness, the image receiving layer (23) and the patch shape-imparting body (200) may be incompletely peeled from the peeling body (100).

As a specific example, the cohesion layer (11) may include one or more selected from the group consisting of polyester, polyacrylate, polyurethane, polyimide, polybutyral, polyacetal, and silicone resin.

As an example, the thickness of the cohesion layer (11) may range from 0.5 to 5 μm, more specifically from 1 to 4 μm, and even more specifically from 2 to 3 μm.

In addition, to adjust the peel strength between the patch film base material (20) and the transport film (10) through the cohesion layer (11) located on one surface of the transport film (10), the one surface of the transport film (10) may be corona-treated or plasma-treated.

As an example, the patch shape-imparting body (200), which is a structure in which the patch film base material (20) and a primer layer (21) are sequentially stacked on the cohesion layer (11) included in the peeling body (100), may include cut-out areas (30, 31).

At this time, the transport film (10) and the patch film base material (20) may be bonded by the cohesion layer (11), and the peel strength between the transport film (10) and the patch film base material (20) can be adjusted based on the bonding process conditions. The bonding process conditions will be described in greater detail in the method for manufacturing the protective patch ribbon for a thermal transfer printer, which will be explained later.

In addition, to adjust the peel strength between the patch film base material (20) and the transport film (10), the surface of the patch film base material (20) that is bonded may also be corona-treated or plasma-treated, similarly or identically to the corona treatment or plasma treatment applied to one surface of the carrier film (10).

In one embodiment, the peel strength between the transport film (10) and the patch film base material (20) may range from 4 to 9 gf/25 mm, specifically from 5 to 8 gf/25 mm, and more specifically from 6 to 7 gf/25 mm based on a 90-degree peel test.

When the peel strength between the transport film (10) and the patch film base material (20) satisfies the 90-degree peel strength as described above, the printed material can be transferred to the recording medium (1) with excellent quality.

Specifically, if the peel strength between the transport film (10) and the patch film base material (20) does not satisfy the aforementioned range based on the 90-degree peel test, there is a possibility that the patch film base material (20) may detach during the formation process of the cut-out areas (30, 31) and the image receiving layer (23) included in the patch shape-imparting body (200) or that the image receiving layer (23) and the patch shape-imparting body (200) may be incompletely peeled from the peeling body (100) during the process of printing the desirous records onto the recording medium (1). Therefore, it is preferable that the peel strength between the transport film (10) and the patch film base material (20) satisfies the aforementioned range based on the 90-degree peel test.

When printing the intended recording medium onto the recording medium (1), the patch film base material (20) included in the patch shape-imparting body (200) is peeled from the peeling body (100) and positioned at the outermost surface of the patch shape (2) area included in the recording medium (1), effectively preventing physical damage to the records.

In one embodiment, the patch film base material (20) may be one or more selected from the group consisting of oriented polypropylene (OPP), polyethylene terephthalate (PET), polyethylene naphthalate (PEN), and polycarbonate (PC).

As a specific example, the thickness of the patch film base material (20) may range from 5 to 40 μm, and more specifically from 10 to 30 μm.

When the thickness of the patch film base material (20) falls within the aforementioned range, the records on the recording medium (1) can be protected from external environmental factors, significantly enhancing the durability of the records.

As an example, the patch film base material (20) may include an embossed hologram. By incorporating an embossed hologram into the patch film base material (20), the security of the records transferred to the recording medium (1) can be enhanced.

In one embodiment, the patch shape-imparting body (200) may have a structure in which the primer layer (21) is positioned on the surface opposite to the bonding surface of the patch film base material (20), which is bonded by the cohesion layer (11), and this structure may include cut-out areas (30, 31).

At this time, the cut-out areas (30, 31) correspond to the area (3) other than the patch shape area (2) included in the recording medium (1). These areas can refer to the area obtained by removing a part of the structure composed of the sequentially laminated patch film base material (20) and primer layer (21) such that the cut-out areas (30, 31) correspond to the entirety of the area (3) other than the patch shape area (2) of the recording medium (1).

In a specific example, the primer layer (21), which is included in the patch shape-imparting body (200) and positioned on the patch film base material (20), serves to enhance the adhesion between the patch film base material (20) and the image-receiving layer (23) (which will be described later), positioned on either side of the primer layer (21).

At this time, the peel strength between the patch film base material (20) and the image-receiving layer (23) bonded via the primer layer (21) may be greater than the peel strength between the transport film (10) and the patch film base material (20).

The primer layer (21) may include any material known in the art that is capable of enhancing adhesion to the patch film base material (20). Non-limiting examples of the primer layer (21) include acrylic resins, urethane resins, amide resins, epoxy resins, ionomer resins, and rubber-based resins.

At this time, the thickness of the primer layer (21) may range from 0.1 to 5 μm, specifically from 1 to 3 μm.

In one embodiment, the image-receiving layer (23), which has an image-receiving function, may be positioned on the patch shape-imparting body (200) and adhered to the patch shape (2) area included in the recording medium (1). Therefore, the image-receiving layer (23) must possess both image-receiving functionality and adhesion to the recording medium (1).

Specifically, the image-receiving layer (23) may include any material capable of receiving sublimation dyes or printing from a color layer melted from a pigment-transfer-type thermal transfer ribbon. However, in terms of enhancing adhesion to the recording medium (1), it may include one or more selected from the group consisting of vinyl chloride homopolymer, vinyl chloride-vinyl acetate copolymer, or polyurethane resins.

Additionally, the image-receiving layer (23) may optionally include known first additives in the art, such as silicone-based plasticizers, release agents, defoamers, leveling agents, polymer waxes, antistatic agents, and the like.

As an example, the thickness of the image-receiving layer (23) can range from 0.5 to 5 μm, preferably from 1 to 4 μm, and more preferably from 1 to 3 μm.

To simultaneously achieve the image-receiving function and adhesion to the recording medium (1), the thickness of the image-receiving layer (23) is preferably within the aforementioned range.

Additionally, the protective patch ribbon (4) can further include a buffer part (not shown) extending integrally from the image-receiving layer (23) to fill the cut-out areas (30, 31) included in the patch shape-imparting body (200). In this case, the buffer part may integrally extend from the image-receiving layer (23) and be made of the same material as that of the image-receiving layer (23).

In one embodiment, the protective patch ribbon (4) may further include a release layer positioned between the image-receiving layer (23) and the primer layer (21).

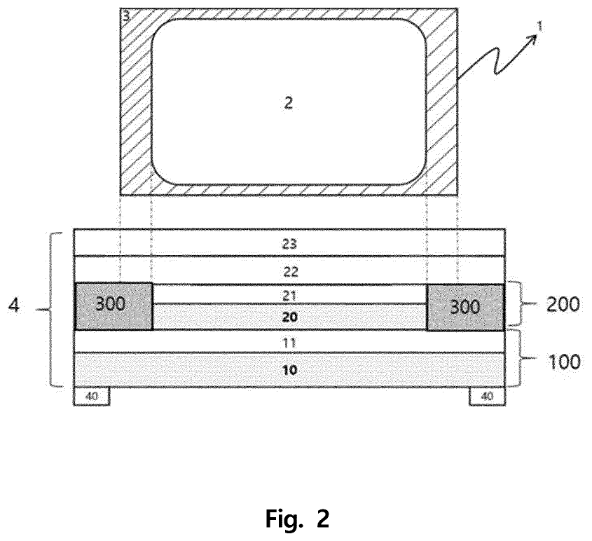

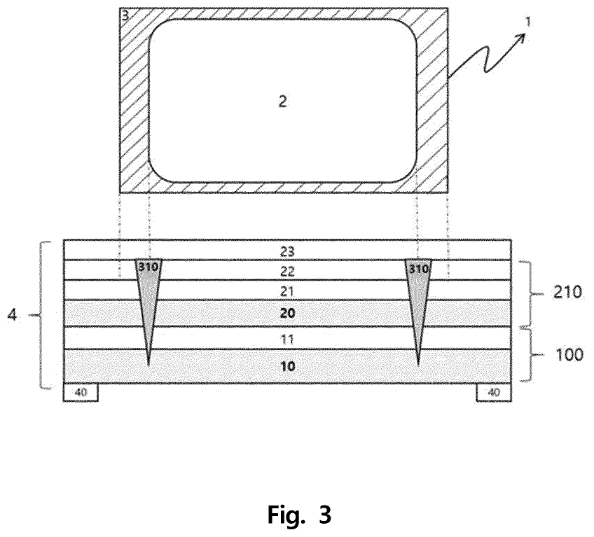

FIGS. 2 and 3 each conceptually illustrate protective patch ribbons (4) that include a release layer (22) according to other embodiments of the present invention.

Referring to FIG. 2, the protective patch ribbon (4) can comprise an peeling body (100) having a cohesion layer (11) positioned on one surface of the transport film (10); a patch shape-imparting body (200), which is a structure obtained by sequentially laminating the patch film base material (20) and primer layer (21) on the cohesion layer (11), and includes cut-out areas (not shown); a release layer (22) positioned on the patch shape-imparting body (200); and an image-receiving layer (23) on the release layer (22).

Here, the protective patch ribbon (4) may further include a first buffer part (300) extending integrally from the release layer (22) to fill a cut-out area.

A peeling body (100) including a cohesion layer (11) positioned on one surface of the transport film (10); a patch shape-imparting body (200), which is a structure obtained by sequentially laminating a patch film base material (20) and a primer layer (21) on the cohesion layer (11) and includes a perforated area (not shown); and the image receiving layer (23) are the same as or similar to those described above, and detailed descriptions are omitted.

The protective patch ribbon (4) further includes the release layer (22) located on the patch shape-imparting body (200), and a first buffer part (300) integrally extended from the release layer and to fill the perforation region. This configuration enhances the print quality of the records in the area (3) where the patch shape (2) area included in the recording medium (1) is not positioned.

In a specific example, the first buffer part (300) is integrally extended from the release layer (22) and may be made of the same material as that of the release layer (22).

The first buffer part (300) is integrally extended from the release layer (22) and is made of the same material as that of the release layer (22). Therefore, this structure can improve the print quality of the transferred, records at both the edge region of the patch shape (2) area and the edge region of the recording medium (1).

In one embodiment, the peel strength between the release layer (22) and the adjacent layers (such as the image receiving layer and the primer layer (21)) and the peel strength between the primer layer (21) and the patch film base material (20) can be greater than the peel strength between the transport film and the patch film base material mentioned earlier.

Upon satisfying the aforementioned conditions, the patch film base material (20) is peeled off from the peeling body (100), which includes a cohesion layer (11) positioned on one surface of the transport film (10). Consequently, the image receiving layer (23) onto which the records has been transferred, along with the release layer (22), the primer layer (21), and the patch film base material (20) can be sequentially retransferred to align with the patch shape (2) defined within the recording medium (1).

At this time, the image receiving layer (23) onto which the records has been transferred, along with the first buffer part (300) integrally extended from the release layer (22), can be sequentially re-transferred onto the area (3) other than the patch shape area (2) included in the recording medium (1).

In one embodiment, the release layer (22), located on the patch-shaped application body (200) and positioned between the image receiving layer (23) and the primer layer (21), can include any polymer resin without limitation, provided it is capable of controlling the glass transition temperature and molecular weight through a cold blending process. As a preferred example, the release layer (22) may include one or more materials selected from the group consisting of polyester, polyacrylate, polyamide, cellulose ester, polyurethane, polyvinyl acetate copolymer, polybutyral, polyacetal, and silicone resin.

To improve transparency and scratch resistance, the release layer (22) may contain polyester and acrylic resins.

Furthermore, the release layer (22) may optionally include known secondary additives, such as defoamers, leveling agents, polymer waxes, and UV blockers.

In one embodiment, the thickness of the adhesion layer (11) and the release layer (22) may each independently range from 0.5 to 5 μm.

At this time, the thickness of the cohesion layer (11) may be the same as described above, and the thickness of the release layer (22) may range from 0.5 to 5 μm, specifically from 1 to 4 μm, and more specifically from 2 to 3 μm. By satisfying the aforementioned thickness range of the release layer (22), the print quality of the transferred, records can be improved, not only in the edge region of the patch shape (2) area included in the recording medium (1), but also in the edge region of the recording medium (1).

Referring now to FIG. 3, a protective patch ribbon (4) may include a peeling body (100) with an adhesion layer (11) located on one surface of the transport film (10); a patch shape-imparting body (210) which includes a layered structure comprising, in sequence, a patch film base material (20), a primer layer (21), and a release layer (22), wherein patch shape-imparting body (210) includes a cut-out area (not shown); and an image receiving layer (23) located on the patch shape-imparting body (210).

Here, the protective patch ribbon (4) may further include a second buffer part (310) integrally extended from the image receiving layer (23) to fill the cut-out area.

The peeling body (100), including the adhesion layer (11) on one surface of the transport film (10), and the image receiving layer (23), are as described earlier, and further details are omitted.

The protective patch ribbon (4) comprises a patch shape-imparting body (210) which is a layered structure comprising, in sequence, a patch film base material (20), a primer layer (21), and a release layer (22) on the cohesion layer (11), the patch shape-imparting body including a cut-out area (not shown); and an image receiving layer (23) located on the patch shape-imparting body (210), and further comprises a second buffer part (310) which is integrally extended from the image receiving layer (23) to fill a cut-out area. This design improves the print quality of records transferred onto the area (3) other than the patch shape area (2) of the recording medium (1).

At this time, the cut-out area corresponds to a part of the layered structure—comprising the patch film base material (20), primer layer (21), and release layer (22)—that has been removed to align with the edge portion of the patch shape (2) area on the recording medium (1). The second buffer part (310), which is integrally extended from the image-receiving layer (23) to fill the cut-out area, is made of the same material as the image-receiving layer (23).

Specifically, the structure included in the patch shape-imparting body (210) includes the release layer (22), and an end portion of the cut-out area, which is part of the structure, on the peeling body side may be recessed within the transport film (10).

As a specific example, the end portion of the cut-out area on the peeling body side may be recessed by 0.2 to 0.8 T, specifically 0.3 to 0.6T, and more specifically 0.4 to 0.5T, relative to the total thickness T of the transport film (10).

As described above, when the end portion of the cut-out area on the release layer side satisfies the specified range and is recessed into the interior of the transport film (10), the cut-out area is filled with a second buffer section (310) made of the same material as the image receiving layer (23). The second buffer section (310) extends integrally from the image receiving layer (23). This enhances the structural stability of the protective patch ribbon (4), ensuring that the records can be transferred to the recording medium (1) without damage during printing.

Additionally, the image receiving layer (23) is positioned on a patch shape-imparting body (210) which includes a structure in which a patch film base material (20), a primer layer (21), and a release layer (22) are sequentially laminated, the structure including a cut-out area, and the cut-out area is filled with a second buffer part (310) integrally extended from the image receiving layer (23). Therefore, the print quality of the records printed on the area (3) other than the patch shape area (2) included in the recording medium (1), is further improved.

In one embodiment, the cut-out area may be tapered in the thickness direction of the protective patch ribbon.

Specifically, the cut-out area may have a tapered shape in which the width of the end portion on the peeling body side is narrower than the width of the opposite end. In this case, the peeling body side end of the cut-out area may have a closed shape at the intersection point with the centerline of the cut-out area, and the centerline may be positioned to align with the edge line of the patch shape (2) on the recording medium (1).

More specifically, the shape of the cut-out area may be formed to include an outer contour (K) that is symmetric about a centerline (L) located at the center of the cut-out area and in contact with both ends of the cut-out area.

As a specific example, the angle between L and K at the point where the peeling body side end of the cut-out area meets the centerline L may range from 5 degrees to 45 degrees, specifically from 10 degrees to 40 degrees, and more specifically from 20 degrees to 30 degrees.

As mentioned above, when the angle between the centerline L and the outer contour K of the perforated area is less than 5 degrees, even if a second buffer part (310) extending integrally from the image receiving layer (23) fills the perforated area, there is a limit to improving the structural stability of the protective patch ribbon (4). Meanwhile, when the angle between L and K exceeds 45 degrees, the structural stability of the protective patch ribbon (4) can be improved, but there is a limit to improving the print quality of the printed material in the area (3) other than the patch shape area (2) on the recording medium (1). Therefore, it is preferable that the angle between the centerline L and the outer contour K of the cut-out area falls within the aforementioned range.

Additionally, when the angle between the centerline L and the outer contour K of the cut-out area is in the range of 20 to 30 degrees, it enhances the structural stability of the protective patch ribbon (4) while also allowing high-quality printing in the area (3) other than the patch shape area (2) included in the recording medium (1) is located, providing the advantage of protecting against physical damage.

The present invention provides a method for manufacturing a protective patch ribbon for thermal transfer printers.

The method for manufacturing the protective patch ribbon for thermal transfer printers according to the present invention comprises the following steps:
a) preparing a peeling body by applying a cohesion layer coating solution to at least one surface of a transport film, which undergoes repeated unrolling and winding;
b) forming a structure by laminating a patch film base material onto a cohesion layer, bonding the patch film base material thereto using a thermal laminator, and then forming a primer layer on a surface of the patch film base material on the opposite side of the laminated surface thereof;
c) forming a patch shape-imparting body by forming a cut-out area in the structure through a die-cutting process such that the patch shape to be transferred to the recording medium is defined; and
d) forming an image-receiving layer on the patch shape-imparting body.

Below, each step of the manufacturing method for the protective patch ribbon for thermal transfer printers will be described in detail.

First, a peeling body is prepared by applying a cohesion layer coating solution to at least one surface of a transport film, which undergoes repeated unrolling and winding, to form the cohesion layer.

In one specific embodiment, the cohesion layer coating solution may consist of a mixed resin containing acrylic resin and polyester, or a reactive resin containing a modified acrylic resin and a curing agent, mixed with a solvent.

In one specific example, the weight ratio of acrylic resin to polyester included in the mixed resin may range from 1:0.01 to 0.2, and more specifically, from 1:0.05 to 0.1.

The weight ratio of modified acrylic resin to curing agent included in the reactive resin may range from 1:0.1 to 0.5, and specifically from 1:0.1 0.3. In this case, the curing agent may include an isocyanate-based curing agent.

Since the cohesion layer coating solution includes a mixed resin or reactive resin that satisfies the aforementioned weight ratio, the patch film base material included in the patch shape-imparting body, formed in the patch shape-imparting body formation step to be described later, can be smoothly released from the peeling body during printing using a conventional retransfer printer. This allows the desired records to be transferred onto the recording medium with excellent quality. In other words, the release strength between the patch film base material and the transport film can be adjusted to improve print quality.

For example, the solvent may be included in the cohesion layer coating solution in an amount of 60 to 90 wt %, specifically 70 to 80 wt %, based on the total weight of the cohesion layer coating solution.

In this case, the solvent may be a single solvent or a mixed solvent of two or more selected from the group consisting of methyl ethyl ketone, dichloromethane, chloroform, ethyl acetate, isopropyl acetate, isobutyl acetate, xylene, and toluene.

The aforementioned cohesion layer coating solution may be applied to at least one surface of the transport film to form a cohesion layer, and any coating method known in the art may be used without limitation. As a non-limiting example, methods such as spray coating, gravure coating, micro-gravure coating, bar coating, slot-die coating, and roll coating can be used to apply the cohesion layer coating solution to at least one surface of the transport film. However, the present invention is not limited by the coating method used.

After applying the cohesion layer coating solution, a drying process may be performed immediately. The drying process may be carried out at a temperature range of 80 to 120° C., specifically 100 to 120° C., for 1 to 3 minutes. After the drying process is completed, a post-curing process can be performed for curing at a temperature range of 60 to 80° C. for 12 to 30 hours, depending on the type of the cohesion layer coating solution.

By performing the post-curing process after the drying process, the patch film base material included in the patch shape-imparting body, which will be formed after the lamination process to be described later, can be smoothly released from the peeling body.

Next, after stacking the patch film base material onto the cohesion layer and laminating it using a thermal laminator, a primer layer is formed on the opposite side of the laminated surface of the patch film base material, thereby forming the structure located on the peeling body.

In this case, the lamination using a thermal laminator can be performed under the conditions of a temperature range of 135 to 145° C. and a feed speed of 1 to 15 m/min, specifically 8 to 12 m/min, or under the conditions of a temperature range of 145.1 to 155° C. and a feed speed of 1 to 9 m/min, specifically 3 to 7 m/min.

Under the aforementioned conditions, the peeling strength between the patch film base material and the transport film, laminated through a thermal laminator with the cohesion layer in between, is controlled. This allows the patch film base material included in the patch shape-imparting body, formed in the patch shape-imparting body formation step to be described later, to be smoothly released from the peeling body during printing using a retransfer printer.

When the lamination conditions through the thermal laminator are not satisfied, the patch film base material may be incompletely peeled from the peeling body during printing using a retransfer printer, or only the primer layer included in the patch shape-imparting body to be described later, or the image receiving layer located on the patch shape-imparting body, may be partially peeled, resulting in degraded print quality. Furthermore, since the printing matter transferred to the recording medium cannot be protected from external environments, it is preferable for the lamination conditions through the thermal laminator to meet the aforementioned conditions.

After laminating the patch film base material and the transport film using a thermal laminator, a primer layer can be applied to the opposite side of the laminated surface of the patch film base material to form a structure located on the aforementioned peeling body. In other words, the structure may have a laminated structure in which the primer layer is positioned on the opposite side of the laminated surface of the patch film base material.

In this case, the primer layer can be formed by applying and drying the primer layer coating solution, and these applying and drying methods may be the same as or similar to those used for applying and drying the aforementioned cohesion layer coating solution.

In one embodiment, the primer layer coating solution may include a modified acrylic resin, a curing agent, and a solvent. The curing agent and solvent included in the primer layer coating solution may be the same as or similar to those included in the aforementioned cohesion layer.

In one specific example, the weight ratio of the modified acrylic resin to the curing agent included in the primer layer coating solution may range from 1:0.01 to 0.095, specifically from 0.05 to 0.09.

When the weight ratio of modified acrylic resin to curing agent included in the primer layer coating solution satisfies the aforementioned ranges, the peeling strength between the primer layer and the patch film base material can be greater than the peeling strength between the patch film base material and the transport film, laminated with the cohesion layer in between. This allows the patch film base material included in the patch shape-imparting body, formed in the patch shape-imparting body formation step to be described later, to be smoothly separated from the peeling body during printing with a retransfer printer, thereby improving print quality.

Next, to define the patch shape to be transferred to the recording medium, a die-cutting process is performed to create cut-out areas in the aforementioned structure, thereby forming the patch shape-imparting body.

In this case, the cut-out area may refer to a region where a portion of the structure, in which the patch film base material and the primer layer are sequentially laminated, is removed through the die-cutting process, corresponding to the entire region other than the intended patch shape.

The die-cutting process can be performed without limitations as long as it employs methods known in the art. In an example, the die-cutting process may be carried out using a rotary die-cut machine, but it is not limited to this method.

Next, an image receiving layer is formed on the patch shape-imparting body, which has a cut-out area in the structure.

The image receiving layer can be formed by applying and drying an image receiving layer coating solution, and these applying and drying methods may be the same as or similar to those for applying and drying the aforementioned cohesion layer coating solution.

In one specific embodiment, the image receiving layer coating solution may include one or more selected from the group consisting of vinyl chloride homopolymer, vinyl chloride-vinyl acetate copolymer, and polyurethane resins dissolved in a solvent.

In one specific example, the image receiving layer coating solution may include 15 to 40 wt %, specifically 20 to 30 wt %, of vinyl chloride-vinyl acetate copolymer based on the total weight of the image receiving layer coating solution. In this case, the solvent may be the same as or similar to the aforementioned solvent.

As an advantageous example, before forming the image receiving layer, that is, after forming the patch shape-imparting body, a step of applying a release layer coating solution to the patch shape-imparting body to form a release layer may be further included.

By applying a release layer coating solution to the patch shape-imparting body with a cut-out area in the aforementioned structure to form the release layer, the release layer coating solution is also applied to the cut-out areas, allowing it to fill the cut-out areas. As a result, there is an advantage in improving the print quality of the printing matter printed in the area other than the patch shape area included in the recording medium.

In one specific example, the release layer coating solution may include an acrylic resin, polyester, and a solvent.

In one specific example, the weight ratio of acrylic resin to polyester in the release layer coating solution may range from 1:0.1 to 0.3, more specifically from 1:0.1 to 0.2.

Here, the solvent may be the same as or similar to the aforementioned one and may constitute 60 to 90%, more specifically 70 to 80% by weight, based on the total weight of the release layer coating solution.

In a more advantageous example, after forming a structure with a release layer included on the primer layer by applying the aforementioned release layer coating solution, cut-out areas can be created in the structure through a die-cutting process to define the patch shape to be transferred onto the recording medium, thereby forming a patch shape-imparting body.

In this case, the cut-out areas may have their peeling body-side ends recessed within the interior of the transport film included in the peeling body.

Specifically, in the cut-out areas formed through the die-cutting process, the width of the peeling body-side ends of the cut-out areas may have a tapered shape, narrower than the width of the opposite ends located on the other side. Additionally, the peeling body-side ends of the cut-out areas may exist in a closed form at the points where they meet the centerline of the cut-out areas. At this point, the peeling body-side ends of the cut-out areas, which exist in a closed form, may be recessed by 0.2 to 0.8T, specifically 0.3 to 0.6T, and more specifically by 0.4 to 0.5T, based on the total thickness T of the transport film, during the die-cutting process.

The cut-out areas formed by this die-cutting process are the same as or similar to the cut-out areas shown in the aforementioned FIG. 3, and a detailed explanation of them is omitted.

As described above, the structure consisting of a patch film base material, a primer layer, and a release layer, which are sequentially stacked, is coated with the aforementioned image receiving layer coating solution on the patch shape-imparting body that includes the tapered cut-out areas, thereby forming the image receiving layer. At this point, the image receiving layer coating solution is applied, filling the tapered cut-out areas, which results in further improvement in the print quality of the records printed in the area other than the patch shape area included in the recording medium.

Hereinafter, the protective patch ribbon for a thermal transfer printer and its manufacturing method according to the present invention will be described in detail through specific examples. However, the following examples are merely references for a detailed explanation of the present invention, and the invention is not limited to these examples and can be implemented in various forms.

Furthermore, unless otherwise defined, all technical and scientific terms have the same meanings as commonly understood by a person skilled in the art to which the present invention belongs. The terms used in the description are intended solely to effectively describe specific examples and are not intended to limit the present invention. Additionally, unless specifically stated otherwise, the units for additives described in the specification may be expressed as weight percent.

### (Manufacturing Example 1) Manufacture of the First Cohesion Layer Coating Solution

A first cohesion layer coating solution was prepared by mixing 2 wt % of amorphous copolyester (VYLON 600, Toyobo), 21 wt % of acrylic resin (BR-83, Mitsubishi Chemical), 38.5 wt % of methyl ethyl ketone, and 38.5 wt % of toluene.

### (Manufacturing Example 2) Manufacture of the Second Cohesion Layer Coating Solution

A second cohesion layer coating solution was prepared by mixing 5 wt % of amorphous copolyester (VYLON 600, Toyobo), 18 wt % of acrylic resin (BR-83, Mitsubishi Chemical), 38.5 wt % of methyl ethyl ketone, and 38.5 wt % of toluene.

### (Manufacturing Example 3) Manufacture of the Third Cohesion Layer Coating Solution

A third cohesion layer coating solution was prepared by mixing 19.3 wt % of modified acrylic resin (hydroxyl value 27 mg/KOH), 2.5 wt % of multifunctional isocyanate (TKA-100, Asahi Kasei), 39.1 wt % of toluene, 23.1 wt % of methyl ethyl ketone, and 16 wt % of ethyl acetate.

### (Manufacturing Example 4) Manufacture of the Fourth Cohesion Layer Coating Solution

A fourth cohesion layer coating solution was prepared by mixing 21.5 wt % of modified acrylic resin (hydroxyl value 27 mg/KOH), 1 wt % of multifunctional isocyanate (TKA-100, Asahi Kasei), 38.8 wt % of toluene, 20.7 wt % of methyl ethyl ketone, and 18 wt % of ethyl acetate.

### (Manufacturing Example 5) Manufacture of Primer Layer Coating Solution

A primer layer coating solution was prepared by mixing 20.2 wt % of modified acrylic resin (hydroxyl value 27 mg/KOH, Tg 60° C.), 1.9 wt % of multifunctional isocyanate (TKA-100, Asahi Kasei), 39 wt % of toluene, 22 wt % of methyl ethyl ketone, and 16.9 wt % of ethyl acetate.

### (Manufacturing Example 6) Manufacture of the First Release Layer Coating Solution

A first release layer coating solution was prepared by mixing 3 wt % of amorphous copolyester (VYLON 600, Toyobo), 21 wt % of acrylic resin (BR-83, Mitsubishi Chemical), 38.5 wt % of methyl ethyl ketone, and 38.5 wt % of toluene.

### (Manufacturing Example 7) Manufacture of the Second Release Layer Coating Solution

A second release layer coating solution was prepared by mixing 6 wt % of amorphous copolyester (VYLON 600, Toyobo), 17 wt % of acrylic resin (BR-83, Mitsubishi Chemical), 38.5 wt % of methyl ethyl ketone, and 38.5 wt % of toluene.

### (Manufacturing Example 8) Manufacture of Image Receiving Layer Coating Solution

An image receiving layer coating solution was prepared by mixing 25 wt % of vinyl chloride-vinyl acetate copolymer (SOLBIN CNL, containing 90 wt % of vinyl chloride and 10 wt % of vinyl acetate, Nissin Chemical Industry), 0.1 wt % of silicone additive (KF-410, Shin-Etsu Chemical), and 74.8 wt % of methyl ethyl ketone.

### Embodiment Example 1

A polyethylene terephthalate film with a thickness of 19 μm was used as a transport film substrate. A first cohesion layer coating solution was applied to one side of this base material using a microgravure method to form a 2 μm thick cohesion layer, preparing the peeling body.

After one side of a 16 μm thick, double-sided corona-treated polyethylene terephthalate film, used as a patch film base material, was laminated to the cohesion layer side of the aforementioned 19 μm thick transport film, lamination was performed using a thermal laminator at a temperature of 150° C. and a feed speed of 5 m/min.

A primer layer coating solution was applied to the opposite side of the laminated patch film base material using the microgravure method to form a 1 μm thick primer layer, producing the structure.

Using a rotary die-cutting machine, portions of the structure were removed through a die-cutting process. Specifically, by removing the entire region other than the intended patch shape, a cut-out area was formed, thereby defining a patch shape smaller than the CR80 standard (86×54 mm) and creating the patch shape-imparting body.

Next, an image receiving layer coating solution was then applied to the formed patch shape-imparting body using the micro-gravure method to form a 2 μm thick image receiving layer, thereby producing a protective patch ribbon for thermal transfer printers.

### Embodiment Example 2

The process was carried out in the same manner as Embodiment Example 1, except that the first release layer coating solution and the image receiving layer coating solution were applied sequentially to the formed patch shape-imparting body using the micro-gravure method to form the release layer and the image receiving layer, with thicknesses of 1.1 μm and 2 μm, respectively.

### Embodiment Example 3

The process was carried out in the same manner as Embodiment Example 1, except that after forming the primer layer, the first release layer coating solution was applied to the primer layer to form a 2.5 μm thick release layer, thereby producing the structure.

Next, through a punching process using a rotary die-cutting machine, a portion of the produced structure was removed to define a patch shape smaller than the CR80 (86×54 mm) standard, forming a patch shape-imparting body that includes a tapered cut-out area with a narrower lower surface. At this point, the peeling body-side ends of the cut-out areas was positioned in a closed form along the centerline of the cut-out area, and the edges of the patch shape were aligned with the centerline of the cut-out area. The peeling body side end of the cut-out area was recessed into the transport film by 40% of its thickness, based on the total thickness of the transport film.

Additionally, the cut-out area was positioned such that its outline was symmetrical on either side of the centerline. At this point, the angle between the centerline and the outline at the closed point of the cut-out area was confirmed to be 25 degrees.

An image receiving layer coating solution was then applied to the formed patch shape-imparting body using the micro-gravure method to form a 2 μm thick image receiving layer, thereby producing the protective patch ribbon for thermal transfer printers.

### Embodiment Example 4

The process was carried out in the same manner as Embodiment Example 3, except that after forming a 3 μm thick cohesion layer using the third cohesion layer coating solution, the patch film base material and transport film were laminated with the cohesion layer in between at a temperature of 140° C. and a feed speed of 10 m/min using a thermal laminator.

### Embodiment Example 5

The process was carried out in the same manner as Embodiment Example 2, except that after forming a 3 μm thick cohesion layer using the third cohesion layer coating solution, the patch film base material and transport film were laminated with the cohesion layer in between at a temperature of 140° C. and a feed speed of 10 m/min using a thermal laminator.

### Embodiment Example 6

The process was carried out in the same manner as Embodiment Example 3, except that the peeling body side end of the cut-out area was recessed into the transport film by 20% of its thickness, based on the total thickness of the transport film.

### Embodiment Example 7

The process was carried out in the same manner as Embodiment Example 3, except that the cut-out area was formed such that the angle between the centerline and the outline at the closed point of the cut-out area was set to 60 degrees.

### Embodiment Example 8

The process was carried out in the same manner as Embodiment Example 3, except that a 16 μm thick, double-sided corona-treated embossed holographic film was used as a patch film base material

### Comparative Example 1

The process was carried out in the same manner as Embodiment Example 3, except that the cohesion layer was formed using the second cohesion layer coating solution.

### Comparative Example 2

The process was carried out in the same manner as Embodiment Example 4, except that the cohesion layer was formed using the fourth cohesion layer coating solution.

### Comparative Example 3

The process was carried out in the same manner as Embodiment Example 4, except that the patch film base material and transport film were laminated with the cohesion layer in between at a temperature of 150° C. and a feed speed of 10 m/min using a thermal laminator.

### Comparative Example 4

The process was carried out in the same manner as Embodiment Example 2, except that the release layer was formed using the second release layer coating solution.

### Comparative Example 5

The process was carried out in the same manner as Embodiment Example 3, except that the die-cutting process to form the patch shape-imparting body was performed after forming the image receiving layer.

### Comparative Example 6

The process was carried out in the same manner as Embodiment Example 3, except that the die-cutting process was not performed, meaning no cut-out area was formed.

### EXPERIMENTAL EXAMPLE

For each of the manufactured protective patch ribbons for thermal transfer printers, the 90-degree peeling strength between the patch film substrate and the transport film, laminated through a thermal laminator with the cohesion layer in between, was measured, and the results were summarized in Table 1.

Additionally, to verify the print quality of each protective patch ribbon for thermal transfer printers, a printing process was performed using a retransfer printer (DC-7600, DASCOM) on a PVC card (CR80 standard) as the recording medium. In this case, the printing was conducted under conditions of a temperature of 202° C. and a feed speed of 20 mm/sec.

The print quality was evaluated by assessing the adhesion between the patch film substrate and the recording medium, as well as the transferability at the edges of the recording medium. The evaluation criteria are described below.

### (Evaluation of Adhesion Between Patch Film Base Material and Recording Medium)

The printed state of the recording medium after the printing process was observed, and one hour later, the patch film base material was forcibly peeled off from the recording medium to check for any tearing.

O: Partial tearing of the patch film base material.

NG: Patch film base material was peeled off without tearing.

X: Printing did not occur, or the patch film base material was not transferred to the recording medium, and only the image receiving layer or the release layer and image receiving layer were transferred.

### (Edge Transferability)

The printed state at the edges of the recording medium after the printing process, specifically in areas other than the patch shape area, was observed.

GOOD: Cut-out areas are not visible, and edge printing is possible.

PASS: Cut-out areas are visible, but edge printing is possible.

NG: Cut-out areas are visible, and edge printing is incomplete.

TABLE 1

| | 90-degree | Adhesion Between | |
|---|---|---|---|
| | Peeling | Patch Film Base | |
| | strength | Material and | Edge |
| | (gf/25 mm) | Recording Medium | Transferability |
| Embodiment Example | 6.7 | O | NG |
| 1 | | | |
| Embodiment Example | 6.7 | O | PASS |
| 2 | | | |
| Embodiment Example | 6.7 | O | GOOD |
| 3 | | | |
| Embodiment Example | 6.3 | O | GOOD |
| 4 | | | |
| Embodiment Example | 6.3 | O | PASS |
| 5 | | | |
| Embodiment Example | 6.7 | NG | GOOD |
| 6 | | | |
| Embodiment Example | 6.7 | O | NG |
| 7 | | | |
| Embodiment Example | 4.2 | O | GOOD |
| 8 | | | |
| Comparative Example | 9.6 | NG | GOOD |
| 1 | | | |
| Comparative Example | 13.6 | X | GOOD |
| 2 | | | |
| Comparative Example | 27.3 | X | GOOD |
| 3 | | | |
| Comparative Example | 6.7 | O | NG |
| 4 | | | |
| Comparative Example | 6.7 | O | NG |
| 5 | | | |
| Comparative Example | 6.7 | X | NG |
| 6 | | | |

Referring to the results in Table 1, when printing was performed using a conventional retransfer printer, it was confirmed that the printing quality was the best when using the protective patch ribbons of Embodiment Example 3 and Embodiment Example 4. On the other hand, even when similar cut-out area similar to Embodiment 3 was included, it was observed that the printing quality varied depending on the shape of the cut-out area.

In contrast, in Comparative Example 6, which does not include a cut-out area, the patch film base material was torn during the printing process, and both the adhesion between the patch film base material and the recording medium, as well as the edge transferability, were observed to be inferior. It was also observed that when the 90° peeling strength between the laminated patch film base material and the transport film exceeded 9 gf/25 mm, the adhesive properties between the patch film base material and the recording medium were poorly exhibited.

Additionally, it was confirmed that the order of performing the die-cutting process to form the cut-out area affected the edge transferability.

As described above, the invention has been explained through the specified details and limited embodiments provided. However, these are intended to aid in the broader understanding of the invention and should not be considered as limiting the invention to these embodiments. A person skilled in the art may make various modifications and alterations based on the disclosed descriptions.

Accordingly, the scope of the invention should not be limited to the described embodiments, but should encompass all equivalents or variations that fall within the spirit and scope of the following claims.

1. A protective patch ribbon for thermal transfer printers comprises:
a peeling body including a transport film that undergoes repeated unrolling and winding, and a cohesion layer located on at least one side of the transport film;
a patch shape-imparting body including a structure in which a patch film base material and a primer layer are sequentially stacked on the cohesion layer, wherein the structure includes a cut-out area; and
an image receiving layer located on the patch shape-imparting body,
wherein the patch shape transferred to the recording medium is defined by the cut-out area.

2. The protective patch ribbon for thermal transfer printers according to claim 1, wherein the transport film and the patch film base material are laminated by the cohesion layer.

3. The protective patch ribbon for thermal transfer printers according to claim 2, further comprising a release layer positioned between the image receiving layer and the primer layer.

4. The protective patch ribbon for thermal transfer printers according to claim 3, further comprising a first buffer portion that extends integrally from the release layer and fills the cut-out area.

5. The protective patch ribbon for thermal transfer printers according to claim 3, wherein the structure may include the release layer, and the peeling body-side end of the cut-out area may be recessed into the interior of the transport film.

6. The protective patch ribbon for thermal transfer printers according to claim 5, wherein the cut-out area is tapered in the thickness direction of the protective patch ribbon.

7. The protective patch ribbon for thermal transfer printers according to claim 6, further comprising a second buffer portion that extends integrally from the image receiving layer and fills the cut-out area.

8. The protective patch ribbon for thermal transfer printers according to claim 3, wherein the peeling strength between the release layer and the layers in contact with the release layer, as well as the peeling strength between the primer layer and the patch film base material, may be greater than the peeling strength between the transport film and the patch film base material.

9. The protective patch ribbon for thermal transfer printers according to claim 8, wherein the peeling strength between the transport film and the patch film base material may be range from 4 to 8 gf/25 mm based on a 90-degree peeling test.

10. The protective patch ribbon for thermal transfer printers according to claim 1, wherein the cohesion layer comprises one or more selected from the group consisting of polyester, polyacrylate, polyurethane, polyimide, polybutyral, polyacetal, and silicone resins.

11. The protective patch ribbon for thermal transfer printers according to claim 3, wherein the release layer comprises one or more selected from the group consisting of polyester, polyacrylate, polyamide, cellulose ester, polyurethane, polyvinyl acetate copolymer, polybutyral, polyacetal, and silicone resins.

12. The protective patch ribbon for thermal transfer printers according to claim 3, wherein the thickness of the cohesion layer and the release layer may each independently be range from 0.5 to 5 μm.

13. The protective patch ribbon for thermal transfer printers according to claim 1, wherein the patch film base material comprises one or more selected from the group consisting of oriented polypropylene (OPP), polyethylene terephthalate (PET), polyethylene naphthalate (PEN), and polycarbonate (PC).

14. The protective patch ribbon for thermal transfer printers according to claim 13, wherein the patch film base material may include an embossed hologram.

15. A method for manufacturing the protective patch ribbon for thermal transfer printers, comprising the following steps:
a) Preparing a peeling body by applying a cohesion layer coating solution to at least one surface of a transport film, which undergoes repeated unrolling and winding to form the cohesion layer;
b) Forming a structure, positioned on the peeling body, by stacking a patch film base material onto the cohesion layer, laminating the patch film base material thereto using a thermal laminator, and then forming a primer layer on the opposite side of the laminated surface of the patch film base material;
c) Forming a patch shape-imparting body by creating a cut-out area on the structure through a die-cutting process such that the patch shape to be transferred to the recording medium is defined; and
d) Forming an image receiving layer on the patch shape-imparting body.

16. The method for manufacturing the protective patch ribbon for thermal transfer printers according to claim 15, further comprising, after step c), applying a release layer coating solution on the patch shape-imparting body to form a release layer.

17. The method for manufacturing the protective patch ribbon for thermal transfer printers according to claim 15, wherein in step b), a release layer coating solution may be applied on the primer layer to form a structure that includes a release layer on the primer layer.

18. The method for manufacturing the protective patch ribbon for thermal transfer printers according to claim 17, wherein in step c), the peeling body-side end of the cut-out area may be recessed into the interior of the transport film.
